(19) United States
(12) Patent Application Publication
(10) Pub. No.: US 2004/0243436 A1
(43) Pub. Date: Dec. 2, 2004

(54) Schemes for scheduling patients for a time period

(76) Inventors: Alok Rawat, Burlington, VT (US); Christopher Starr, Baltimore, MD (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/448,716

(22) Filed: May 30, 2003

(51) Int. Cl. G06F 17/60; G06G 7/00; G06F 17/00

(52) U.S. Cl. 705/2; 705/400

(57) ABSTRACT

Schemes for scheduling patients for a time period are described herein. These schemes can compute a financial consequence associated with a medical service provided to a patient. These schemes can determine a schedule of patients for a time period based on one or more criteria selected by a healthcare provider, such as a clinical practice standard and a financial consequence associated with the schedule.

### BACKGROUND

Healthcare providers such as doctors and nurses can provide medical services to patients. Healthcare providers can schedule their patients for a time period based on the availability of the providers and the patients.

A variety of schemes for scheduling patients for a time period are presently available. Many of these schemes do not consider clinical practice standards and financial consequences associated with a medical service provided to the patient, thereby inhibiting their utility.

### SUMMARY

Schemes for scheduling patients for a time period are described herein. These schemes can compute a financial consequence associated with a medical service provided to a patient. These)schemes can determine a schedule of patients for a time period based on one or more criteria selected by a healthcare provider, such as a clinical practice standard and a financial consequence associated with the schedule.

A method for determining a schedule of patients for a time period is described herein. In one embodiment, the method can comprise providing a profit scheme capable of computing a profit associated with a procedure of a patient; based on the profit scheme, computing profits associated with different schedules of procedures-of the patients for the time period; and, based on the computed profits, selecting one of the different schedules of procedures of patients for the time period.

In one aspect, providing a profit scheme can comprise providing an earnings component representing at least one computed insurance reimbursement for the procedure and providing a costs component representing at least one computed value of unbillable healthcare provider time for the procedure.

In one aspect, providing an earnings component can comprise representing, in the earnings component, the at least one computed insurance reimbursement based on at least one empirical relationship between the maximum insurance reimbursement for the procedure and at least one historical reimbursement for the procedure.

In one aspect, providing an earnings component can comprise representing, in the earnings component, the at least one computed insurance reimbursement based on at least one empirical relationship among the maximum insurance reimbursement for the procedure, at least one patient factor comprising at least one of an age, a diagnosis, an employer, a level of impairment, a past medical history, and a monetary consequence for an unattended procedure, and at least one historical reimbursement for the procedure.

In one aspect, providing an earnings component can comprise providing an earnings component representing at least one computed patient co-payment for the procedure.

In one aspect, providing an earnings component can comprise representing, in the earnings component, the at least one computed patient co-payment based on at least one empirical relationship between the maximum patient co-payment for the procedure and at least one historical patient co-payment for the procedure.

In one aspect, providing an earnings component can comprise representing, in the earnings component, the at least one computed patient co-payment based on at least one empirical relationship among a maximum patient co-payment for the procedure, at least one patient factor comprising at least one of an age, a diagnosis, an employer, a level of impairment, a past medical history, and a monetary consequence for an unattended procedure, and at least one historical patient co-payment for the procedure.

In one aspect, providing an earnings component can comprise providing an earnings component based on at least one compensation type comprising at least one of a base salary, a bonus, a fee for a service, and an hourly wage.

In one aspect, the at least one computed value of unbillable healthcare provider time can be based on at least one of: at least one non-patient interaction comprising at least one of at least one healthcare provider telephone call, at least one healthcare provider documentation, and at least one healthcare provider laboratory report, and at least one unattended procedure comprising at least one of at least one patient-cancelled procedure, and at least one patient-missed procedure.

In one aspect, providing a costs component can comprise representing, in the costs component, the at least one computed value of unbillable healthcare provider time based on at least one product of: at least one healthcare provider hourly rate, and at least one amount of unbillable healthcare provider time for the procedure.

In one aspect, the at least one amount of unbillable healthcare provider time can be based on at least one average of amounts of historical unbillable healthcare provider time for the procedure.

In one aspect, the at least one amount of unbillable healthcare provider time can be based on at least one empirical relationship between at least one patient factor comprising at least one of an age, a diagnosis, an employer, a level of impairment, a past medical history, and a monetary consequence for an unattended procedure, and at least one amount of historical unbillable healthcare provider time for the procedure.

In one aspect, providing a costs component can comprise providing a costs component representing at least one computed business cost for the procedure.

In one aspect, providing a costs component can comprise representing, in the costs component, the at least one computed business cost based on at least one proportional relationship between at least one outlay comprising at least one of: a rent payment, a utilities payment, a labor cost, and a malpractice insurance premium, and at least one duration of at least one procedure.

In one aspect, computing profits can comprise, based on the profit scheme, computing profits associated with different procedures of at least one patient.

In one aspect, the different procedures can comprise at least one of: at least one clinically-indicated procedure, and at least one insurer-authorized procedure.

In one embodiment, the method can further comprise, based on at least one of at least one clinically-indicated procedure, and at least one insurer-authorized procedure, generating the different schedules of procedures of the patients.

A method for determining a procedure of a patient is described herein. In one embodiment, the method can comprise providing a profit scheme based on at least one computed insurance reimbursement and at least one computed value of unbillable healthcare provider time for a procedure of a patient; based on the profit scheme, computing profits associated with different procedures of the patient; and, based on the computed profits, selecting one of the different procedures of the patient.

A method for computing a profit associated with a schedule of patients is described herein. In one embodiment, the method can comprise providing a profit scheme based on at least one computed insurance reimbursement and at least one computed value of unbillable healthcare provider time for a procedure of a patient; based on the profit scheme, computing profits associated with the procedures of the patients of the schedule; and, based on the computed profits, computing the profit associated with the schedule.

A processor program for determining a schedule of patients for a time period is described herein. The processor program can be stored on a processor readable medium. In one embodiment, the processor program can comprise instructions to cause a processor to compute profits associated with different schedules of procedures of patients for the time period based on a profit scheme capable of computing a profit associated with a procedure of a patient. The processor program can further comprise instructions to cause a processor to select one of the different schedules of procedures of patients for the time period based on the computed profits.

These and other features of the schemes for scheduling patients for a time period described herein can be more fully understood by referring to the following detailed description and accompanying drawings. In the drawings, reference numerals that differ by increments of 100 refer to similar components in different embodiments.

### BRIEF DESCRIPTION OF THE DRAWINGS

FIG. 1 schematically illustrates an embodiment of a profit scheme for computing a profit associated with a procedure of a patient.

FIG. 2 schematically illustrates an embodiment of a profit scheme having a fitting component and a profit component.

FIG. 3 schematically illustrates an embodiment of a profit scheme based on a factor.

FIG. 4 schematically illustrates an embodiment of a profit scheme having an earnings component, a costs component, and a profit component.

FIG. 5 schematically illustrates an embodiment of a profit scheme for computing a profit associated with a patient.

FIG. 6 schematically illustrates an embodiment of a profit scheme for computing a profit associated with a schedule of patients.

FIG. 7 schematically illustrates an embodiment of a scheduling scheme for determining a schedule of patients for a time period.

FIG. 8 schematically illustrates a flow diagram of an exemplary operation of the scheduling scheme of FIG. 7.

FIG. 9 schematically illustrates an embodiment of a stand-alone system configured to implement the schemes described herein.

FIG. 10 schematically illustrates an embodiment of a network-based system configured to implement the schemes described herein.

### DETAILED DESCRIPTION

Generally, the schemes described herein can determine a schedule of patients for a time period. A schedule of patients can include a schedule of procedures to be provided to the patients for the time period. A procedure can include a service provided by a healthcare provider. The schemes described herein can determine a schedule of patients for a time period based on clinical practice standards and/or financial consequences associated with the schedule.

As will be understood by those of ordinary skill in the art, financial consequences can have values that are greater than, less than, or equal to zero. As such, references herein to profits can be more generally understood to be references to financial consequences, in which financial consequences can include gains (i.e. positive returns), losses (i.e. negative returns), and zero returns.

The profit associated with the schedule can be computed based on profits associated with the patients of the schedule. The profit associated with a patient of the schedule can be computed based on a difference between an earnings component and a costs component for the procedure of the patient. In embodiments, the earnings component can represent a computed insurance reimbursement for the procedure and can be based on an empirical relationship between a maximum insurance reimbursement for the procedure and past reimbursements for past procedures. Alternatively or in combination, in embodiments, the earnings component and/or the costs component can be based on a compensation type of a healthcare provider. In embodiments, the costs component can represent a computed value of unbillable healthcare provider time for the procedure. Unbillable healthcare provider time can include time spent by a healthcare provider on a procedure of a patient for which the healthcare provider cannot bill an insurer or a patient. In embodiments, the schemes can determine the n-most profitable schedules of patients for a time period, where n represents an integer.

Generally, the schemes described herein can compute a profit associated with a schedule of patients. In embodiments, the schedule can be based on clinically-indicated procedures, insurer-authorized procedures, procedures preferred by a healthcare provider, and/or other procedures. Alternatively or in combination, in embodiments, the schedule can be based on a compensation type of a healthcare provider.

Generally, the schemes described herein can determine a procedure of a patient based on computing profits associated with different procedures of the patient. In embodiments, the procedures can be based on clinically-indicated procedures, insurer-authorized procedures, procedures preferred by a healthcare provider, and/or other procedures.

Generally, the schemes described herein can compute a profit associated with a medical practice of a healthcare provider. In embodiments, a healthcare provider can use the profit associated with the practice to determine a financial viability of the practice. In embodiments, a healthcare provider can choose a practice based on profits associated with different practices.

Illustrative embodiments will now be described to provide an overall understanding of the schemes for scheduling patients for a time period. One or more examples of the illustrative embodiments are shown in the drawings. Those of ordinary skill in the art will understand that the schemes described herein can be adapted and modified to provide devices, methods, schemes, and systems for other applications, and that other additions and modifications can be made to the schemes described herein without departing from the scope of the present disclosure. For example, aspects, components, features, and/or modules of the illustrative embodiments can be combined, separated, interchanged, and/or rearranged to generate other embodiments. Such modifications and variations are intended to be comprised within the scope of the present disclosure.

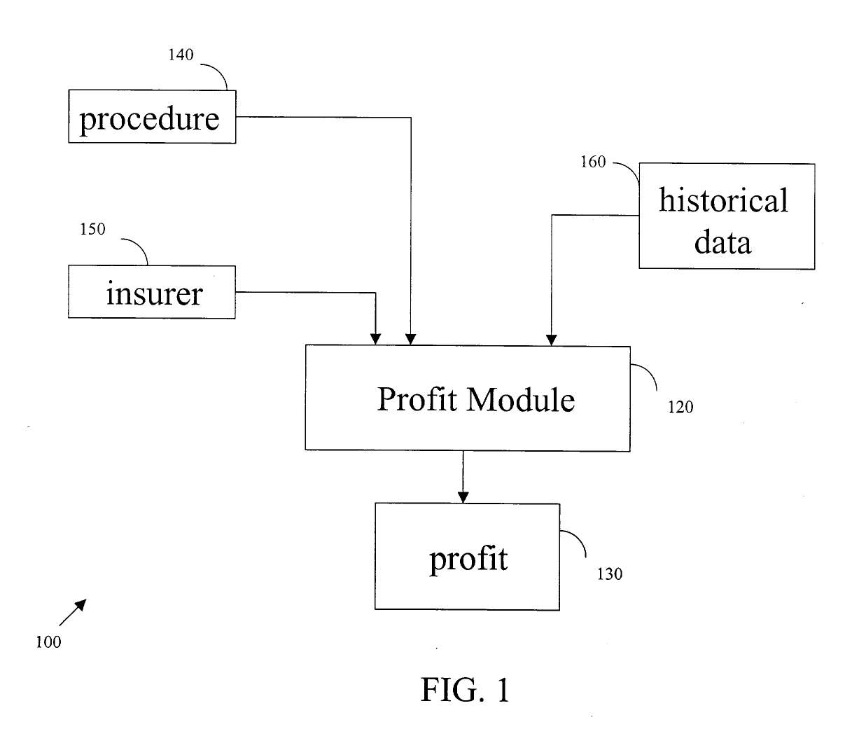

FIG. 1 shows a profit scheme 100 that can compute a profit associated with a procedure of a patient. As shown in FIG. 1, the scheme 100 can include a profit module 120 that computes a profit 130 based on a procedure 140, an insurer 150, and historical data 160. The procedure 140 represents a medical service to be provided by a healthcare provider to a patient. The procedure 140 can represent a medical treatment, a surgical operation, and/or other medical services. A healthcare provider can include a doctor, a nurse, and/or other workers in the healthcare field. The insurer 150 represents an entity that provides medical insurance to the patient. The insurer 150 can represent a health maintenance organization (HMO) (e.g. Harvard Pilgrim HMO), a primary physician organization (PPO) (e.g. Blue Cross Blue Shield PPO), a government program, (e.g. Medicaid and Medicare), a private insurer, a self-paying patient, and other medical insurers. The historical data 160 includes data based on insurers and past procedures that can be used by the profit module 120 to compute a profit for a present procedure 140. The historical data 160 can include data based on one or more past reimbursements provided by one or more insurers to one or more healthcare providers for one or more past procedures. For example, the historical data 160 can include a maximum reimbursement by an insurer for a procedure (e.g. a maximum reimbursement for a surgical operation to remove a gall bladder) and past reimbursements provided by the insurer to a healthcare provider for past procedures (e.g. past reimbursements for past surgical operations to remove gall bladders). Based on the historical data 160, the profit module 120 can generate an empirical relationship between the maximum reimbursement by the insurer 150 for the procedure 140 and past reimbursements by the insurer 150 for past procedures corresponding to the procedure 140. The profit module 120 can compute a profit 130 for the procedure 140 by applying the empirical relationship to the maximum reimbursement by the insurer 150 for the procedure 140.

The historical data 160 can include data based on procedures that occurred prior to a time of a present procedure 140. For example, the historical data 160 can include data based on procedures that occurred years, months, weeks, days, hours, minutes, and/or seconds prior to a present procedure 140.

In embodiments, the historical data 160 can be updated to reflect changes in data based on reimbursements provided by insurers to healthcare providers for procedures. In one such embodiment, the historical data 160 can be updated periodically to reflect changes. For example, the historical data 160 can be updated yearly, monthly, weekly, daily, hourly, etc.

In embodiments, the historical data 160 can include data based on past reimbursements provided by insurers to one or more healthcare providers. In one embodiment, the historical data 160 can include data based on past reimbursements provided to a single healthcare provider. In such an embodiment, the profit module 120 can compute a profit for a procedure to be provided by a healthcare provider based on the past reimbursements received by the healthcare provider. Alternatively, in one embodiment, the historical data 160 can include data based on past reimbursements provided to different healthcare providers. In such an embodiment, the profit module 120 can compute a profit for a procedure to be provided by a healthcare provider based on past reimbursements received by the healthcare provider and other healthcare providers.

In embodiments, the historical data 160 can be associated with one or more factors that can distinguish different healthcare providers. For example, in one such embodiment, the factors can represent a professional competency of a healthcare provider, a compliance by a healthcare provider with insurer procedures, and other related information.

As previously described, a procedure can represent a medical service to be provided by a healthcare provider to a patient. A procedure can include two or more components separated in time. For example, a procedure can include an office visit at a first time and one or more follow-up visits at a second time later than the first time. The two or more components can include different time durations. For example, an initial office visit can include a first time duration, and a follow-up visit can have a different second time duration. In embodiments, the schemes described herein can compute a profit for a procedure based on computing profits for the components of the procedure. For example, the schemes described herein can compute a profit for a procedure by computing a profit for an initial office visit, computing profits for one or more follow-up visits, and summing the profits for the initial office visit and the follow-up visits.

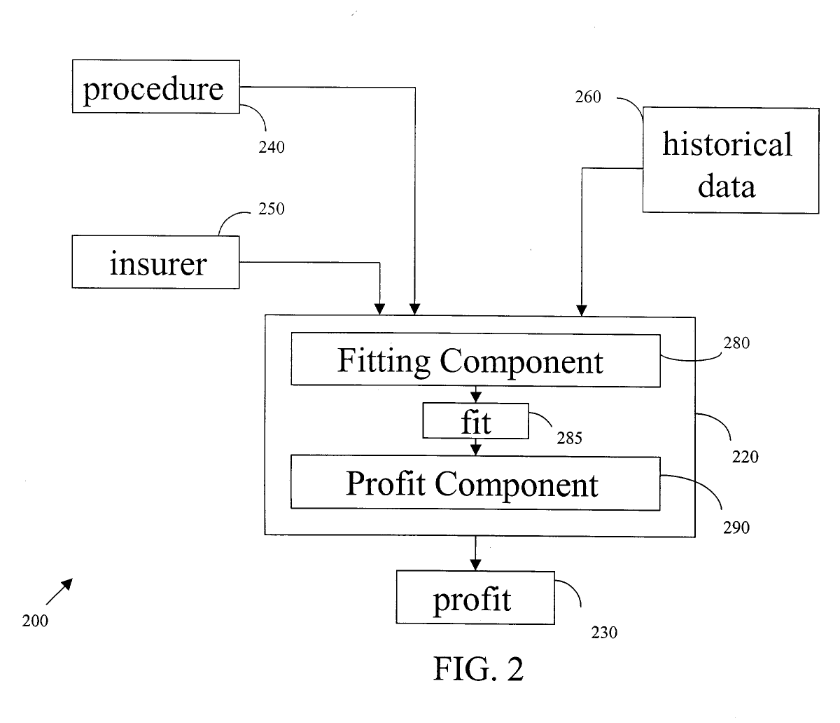

FIG. 2 shows a profit scheme 200 having a profit module 220 with a fitting component 280 and a profit component 290. The fitting component 280 can be configured to generate an empirical relationship 285 based on the historical data 260 based on one or more mathematical and/or statistical schemes familiar to those of ordinary skill in the art. In one embodiment, the fitting component 280 can be configured to generate one or more one-variable and/or many-variable empirical relationships 285 based on one or more regression schemes familiar to those of ordinary skill in the art. As shown in FIG. 2, the fitting module 280 can provide the empirical relationship 285 to the profit component 290, and the profit component 290 can be configured to apply the empirical relationship 285 to compute a profit 230. The fitting component 280 can generate the empirical relationship 285 on a time scale that can be dynamic (i.e. based on receiving an input), periodic (i.e. based on a pre-determined time, such as a pre-determined time for an update of the historical data 260), or random.

In a non-limiting and illustrative example, the historical data 260 can include data from a healthcare provider for past patients associated with the same procedure. The past patients can be associated with their insurers, reimbursements received from their insurers for the procedure, and the maximum reimbursements by their insurers for the procedure. The fitting component 280 can fit the historical data 260 to generate a fit 285 between the maximum reimbursements by the insurers for the past procedure and the past reimbursements received by the healthcare provider for the past procedure. The fit 285 can be specific to an insurer. The profit component 290 can apply the fit 285 to a procedure 240 of a present patient and an insurer 250 of the patient to compute the profit 230 for the procedure 240.

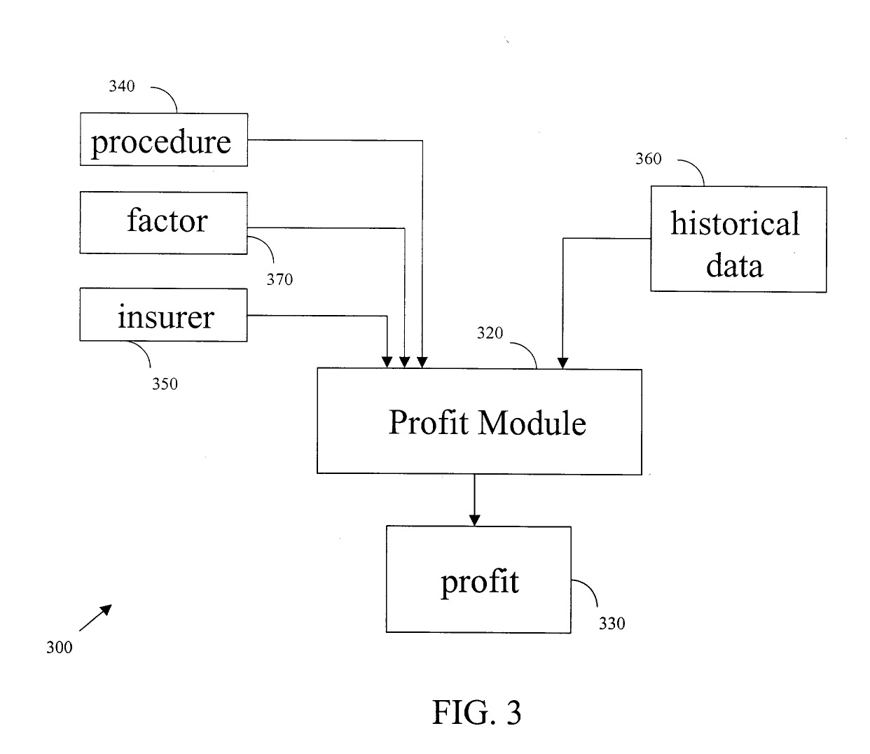

FIG. 3 shows a profit scheme 300 that can compute a profit associated with a procedure of a patient based on a factor. A profit for a procedure of a patient can depend on one or more features of the patient, the procedure, the healthcare provider, and the insurer. As shown in FIG. 3, the scheme 300 can include a profit module 320 that computes a profit 330 based on a procedure 340, an insurer 350, one or more factors 370, and historical data 360. In one embodiment, the factors 370 can represent features of the patient, such as one or more of an age, a diagnosis, an employer, a level of impairment, a past medical history, and a monetary consequence for an unattended visit with a healthcare provider (e.g. an amount of money forfeited by the patient for an unattended visit). In such an embodiment, the historical data 360 can include data based on past reimbursements provided by insurers for past procedures and past patient factors associated with the past procedures. The historical data 360 can include a maximum reimbursement by an insurer for a procedure (e.g. a maximum reimbursement for a surgical operation to remove a gall bladder), past reimbursements provided by the insurer for past procedures (e.g. past reimbursements for past surgical operations to remove gall bladders), and past patient factors associated with the past procedures (e.g. ages of past patients who received surgical operations to remove gall bladders). Based on historical data 360, the profit module 320 can generate an empirical relationship among the maximum reimbursement by the insurer 350 for the procedure 340, past reimbursements by the insurer 350 for past procedures corresponding to the procedure 340, and past patient factors associated with the past procedures corresponding to the procedure 340. The profit module 320 can compute a profit 330 for the procedure 340 by applying the empirical relationship to the patient factors 370 and the maximum reimbursement by the insurer 350 for the procedure 340.

With continuing reference to the non-limiting and illustrative example described with respect to FIG. 2, the historical data 360 can include patient factors, such as the ages of the past patients associated with the same procedure. The profit module. 320 can generate a multivariable empirical relationship among the maximum reimbursements by the insurers for the past procedure, the past reimbursements received by the healthcare provider for the past procedure, and the ages of the past patients. The empirical relationship can be specific to an insurer. The profit module 320 can apply the empirical relationship to a procedure 340 of a present patient, an age 370 of the patient, and an insurer 350 of the patient to compute the profit 330 for the procedure 340.

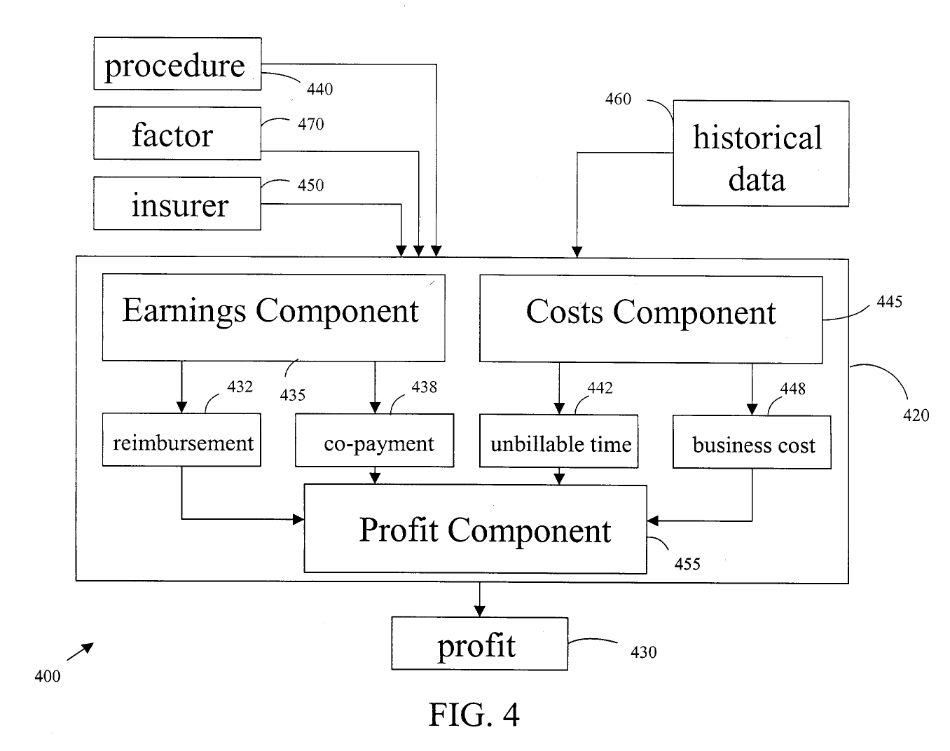

FIG. 4 shows an embodiment of a profit scheme 400 having a profit module 420 with an earnings component 435, a costs component 445, and a profit component 455. As shown in FIG. 4, the earnings component 435 can compute a reimbursement 432 from an insurer 450 and a co-payment 434 from a patient for a procedure 440 based on historical data 460, the costs component 445 can compute a value of unbillable healthcare provider time 442 and a business cost 448 for the procedure 440 based on historical data 460, and the profit component 455 can compute a profit 430 for the procedure 440 based on one or more mathematical and/or statistical relationships between the fields 432, 438, 442, and 448. For example, the profit component 455 can compute the profit 430 based on a difference, a difference of sums, a difference of squares, a square root of a difference of squares, and/or another mathematical and/or statistical relationship between the fields 432, 438, 442, 448. In one embodiment, the profit component 455 can compute the profit 430 based on a difference between a sum of the computed reimbursement 432 and the computed co-payment 438 and a sum of the computed value of unbillable healthcare provider time 442 and the computed business cost 448.

As shown in the embodiment of FIG. 4, the earnings component 435 can compute a reimbursement 432 from an insurer 450 and a co-payment 438 from a patient for a procedure 440 based on schemes previously described herein. A co-payment represents an insurer-dependent fee that a patient pays to a healthcare provider to receive a medical service from the provider. A co-payment can be determined by an insurer and can be fixed (i.e. independent of the procedure 440) or variable (i.e. dependent on the procedure 440). The earnings component 435 can compute the reimbursement 432 and the co-payment 438 based on the procedure 440, the insurer 450, one or more factors 470 (e.g. patient factors), and historical data 460. The historical data 460 can include data based on insurers, past procedures, and past co-payments. The historical data 460 can include a maximum reimbursement by an insurer for a procedure, past reimbursements by insurers for past procedures, a maximum co-payment for a procedure, past co-payments by patients for past procedures, and past factors (e.g. patient factors) associated with past procedures. Based on the historical data 460 and the schemes previously described, the earnings component 435 can compute the reimbursement 432 and the co-payment 438. More generally, the earnings component 435 can compute one or more reimbursements 432 from one or more insurers 450 that provide medical insurance to the patient and one or more co-payments 438 associated with the one or more insurers 450 of the patient.

Alternatively or in combination, in one embodiment, the earnings component 435 can compute a compensation for a procedure 440 based on a product of a present healthcare provider compensation type and an average duration of corresponding past procedures included in the historical data 460. The compensation type can include a base salary, a bonus, a fee for a service, and/or an hourly wage. The compensation type can be a supplement to or independent of reimbursements from an insurer. The average duration of corresponding past procedures can be based on empirical data provided by one or more healthcare providers.

As shown in the embodiment of FIG. 4, the costs component 445 can compute a value of unbillable healthcare provider time 442 for a procedure 440 based on schemes previously described herein. Unbillable healthcare provider time represents time that a healthcare provider spends on or otherwise allocates to a procedure for which the healthcare provider cannot bill an insurer or a patient. Unbillable healthcare provider time can include time spent by a healthcare provider on a non-patient interaction, such as a case documentation, a laboratory report, and/or a telephone call related to a procedure and time lost by a healthcare provider to an unattended patient procedure, such as a patient-cancelled procedure and/or a patient-missed procedure.

The costs component 445 can compute the value of unbillable healthcare provider time based on the procedure 440, one or more factors 470 (e.g. patient factors), and the historical data 460. The historical data 460 can include data based on past procedures, factors associated with the past procedures, present healthcare provider compensation rates for a time period (e.g. hourly compensation rates), and past amounts of unbillable healthcare provider time associated with the past procedures. The past amounts of unbillable healthcare provider time can be based on empirical data from one or more healthcare providers. In one embodiment, the costs component 445 can compute an amount of unbillable healthcare provider time for a present procedure 440 based on one or more mathematical and/or statistical relationships (e.g. an average) between past amounts of unbillable healthcare provider time for corresponding past procedures. In such an embodiment, the costs component 445 can compute the value of unbillable healthcare provider time 442 based on a product of the computed amount of the unbillable healthcare provider time and the present healthcare provider compensation rate.

Alternatively or in combination, in one embodiment, the costs component 445 can generate an empirical relationship between the past amounts of unbillable healthcare provider time for past procedures and the past factors associated with the past procedures based on schemes previously described herein. In such an embodiment, the costs component 445 can compute an amount of unbillable healthcare provider time by applying the empirical relationship to the factors 470 and the past amounts of unbillable time. The costs component 445 can compute the value of unbillable healthcare provider time 442 based on a product of the computed amount of the unbillable healthcare provider time and the present healthcare provider compensation rate.

As shown in FIG. 4, the costs component 445 can compute a business cost 448 for a procedure 440. A business cost 448 represents a cost that a healthcare provider pays to maintain a business in which to provide medical services. A business cost 448 can include an outlay such as a rent payment (e.g. a rent payment for an office and a rent payment for equipment), a utilities payment, a labor cost, a malpractice insurance premium, and other outlays to maintain a business. The costs component 445 can compute the business cost 432 based on the procedure 440 and historical data 460. The historical data 460 can include data based on present business costs and durations of past procedures. The durations of past procedures can be based on empirical data from one or more healthcare providers. Based on the historical data 460, the cost's component 445 can generate a proportional relationship between present business costs and durations of past procedures corresponding to the procedure 440. The costs component 445 can compute the business cost 448 by applying the proportional relationship to the present business costs and the present procedure 440.

In one embodiment, the costs component 445 can compute the business cost 448 for the procedure 440 based on a pro-rata relationship between the durations of corresponding past procedures and present business costs. For example, in such an embodiment, the historical data 460 can include a present office space rent and durations of corresponding pasts procedure. Based on the historical data 460, the costs component 445 can compute the business cost 448 for a present procedure 440 based on a product of average durations of corresponding past procedures and the present office space rent.

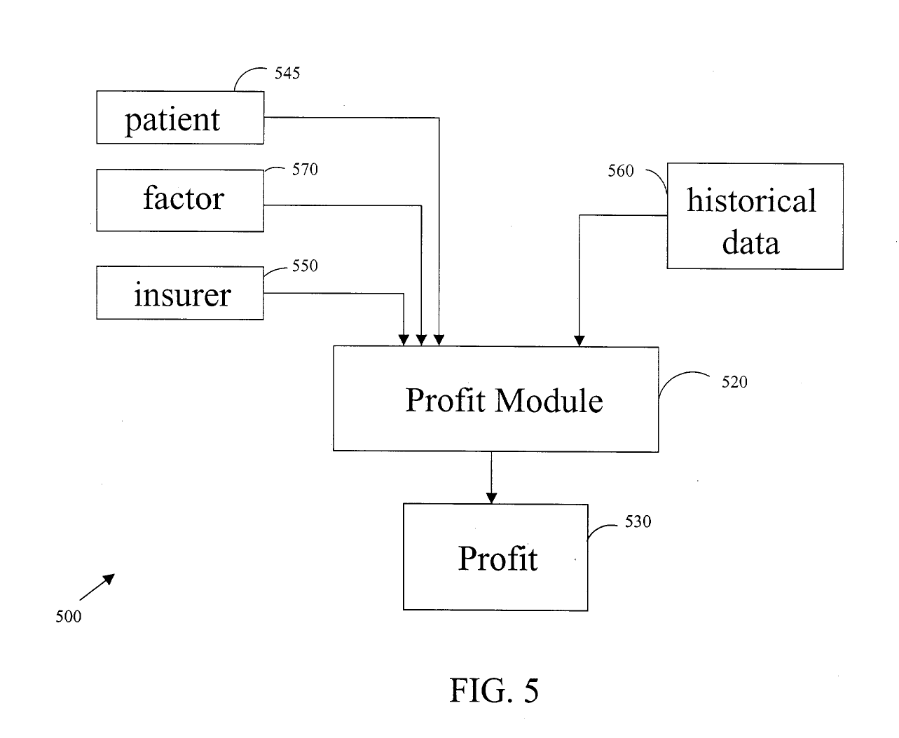

FIG. 5 shows an embodiment of a profit scheme 500 that can compute a profit associated with a patient. A healthcare provider can often choose between two or more different procedures for a patient. For example, a healthcare provider of a substance-abuse patient can prescribe a drug for the patient and/or can recommend a therapy for the patient such as a drug rehabilitation program. As shown in FIG. 5, the scheme 500 can include a profit module 520 that computes a profit 530 based on a patient 545, an insurer 550, one or more factors 570, historical data 560, and schemes described herein.

In one embodiment, the patient 545 can be associated with two or more different procedures based on a medical diagnosis. For example, the patient 545 can be associated with a clinically-indicated procedure (e.g. a procedure based on a recommendation from clinical literature), an insurer-authorized procedure (e.g. a procedure based on a recommendation from an insurer), a procedure preferred by a healthcare provider for the diagnosis, and/or other available procedures. In such an embodiment, the profit module 520 can compute a profit for each of the two or more different procedures associated with the patient 545 based on the schemes described herein.

Alternatively or in combination, in one embodiment, the patient 545 can be associated with a medical diagnosis and the historical data 560 can include procedures associated with past medical diagnoses. The past medical diagnoses and associated procedures can be based on empirical data from one or more healthcare providers. In such an embodiment, the profit module 520 can compute the n-most profitable procedures for the patient 545 based on the medical diagnosis and the schemes described herein.

The profit scheme 500 can compute profits associated with a variety of different procedures. As previously described, in one embodiment, the profit scheme 500 can determine the n-most profitable procedures. In such an embodiment, the profit scheme 500 can optimize for profit over procedures. Alternatively or in combination, in one embodiment, the profit scheme 500 can determine profits associated with particular procedures. For example, the profit scheme 500 can determine profits associated clinically-indicated procedures, insurer-authorized procedures, procedures preferred by a healthcare provider, and/or other procedures.

Generally, the profit scheme 500 can be configured to select one or more schedules based on a profit associated with the schedule. For example, in one embodiment, the profit scheme 500 can be configured by a healthcare provider to select the most profitable procedure. In such an embodiment, the profit scheme 500 can compute the n-most profitable procedures and select the most profitable procedure for provision to another application, such as a scheduling scheme as described herein, and/or a healthcare provider.

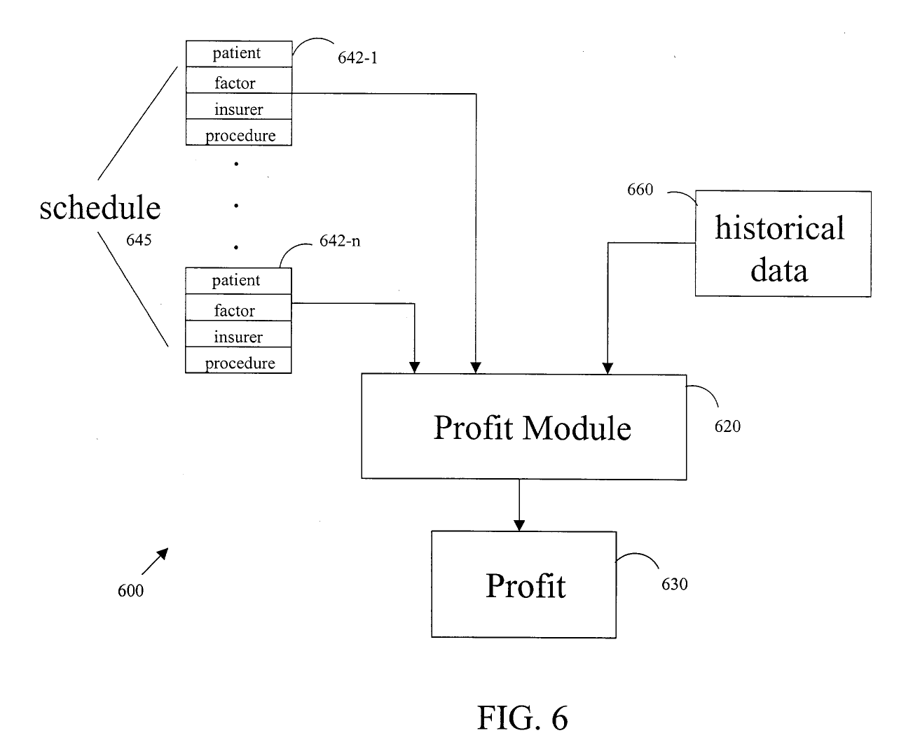

FIG. 6 shows an embodiment of a profit scheme 600 that can compute a profit associated with a schedule of patients. As shown in FIG. 6, the profit scheme 600 can include a profit module 620 that computes a profit 630 based on a schedule of patients 645, historical data 660, and schemes described herein.

A schedule of patients can include a set of procedures to be provided to one or more patients in a time period. The time period can include a day, a week, a month, a year, and/or a different time period. As shown in FIG. 6, the schedule 645 can include patients and associated factors, insurers, and procedures 642-1, . . . , 642-1. The profit module 620 can compute the profit 630 for the schedule 645 by computing profits for the procedures 642-1, . . . , 642-n based on the schemes described herein and summing the computed profits.

In embodiments, the profit module 620 can compute two or more profits 630 for the schedule-645 based on different procedures for the patients. For example, the profit module 620 can compute a profit for the schedule 645 based on clinically-indicated procedures, insurer-authorized procedures, procedures preferred by a healthcare provider, and/or other procedures. Based on the schemes described herein, the profit module 620 can compute the n-greatest profits for the schedule 645, i.e. the n-most profitable sets of procedures for the schedule 645.

In embodiments, the profit schemes described herein can compute a profit associated with a medical practice of a healthcare provider. A medical practice can describe medical services provided by a healthcare provider. For example, a medical practice can include a children's psychiatry practice, in which a healthcare provider provides psychiatric medical services to children. The profit schemes can compute a profit associated with a medical practice based on computing a profit associated with a schedule of representative patients associated with the medical practice. A healthcare provider can determine a financial viability of a medical practice and choose among different medical practices based on profits associated with the practices.

In a non-limiting and illustrative example, the profit schemes described herein can compute a profit associated with a children's psychiatric practice. The profit schemes can compute the profit based on a schedule of patients representative of such a practice. For example, the schedule can include children patients associated with procedures representative of the practice. The representative procedures can be based on past procedures of one of more healthcare providers in the psychiatric practice, clinical literature, insurer data, and other sources of information.

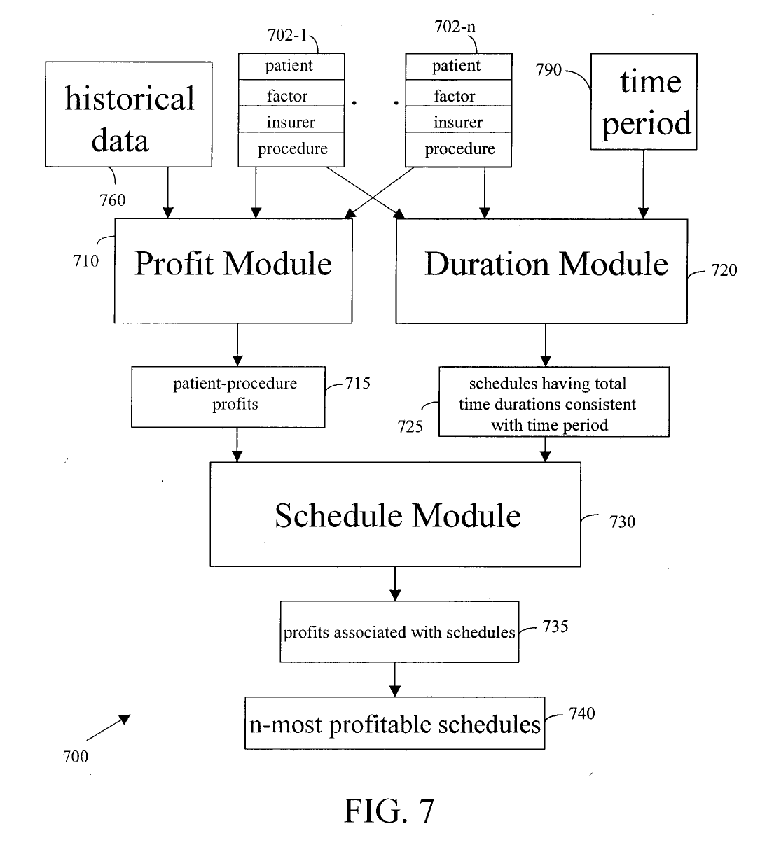

FIG. 7 shows a scheduling scheme 700 that can determine a schedule of patients for a time period based on a profit associated with the schedule. As shown in FIG. 7, the scheme 700 can include a profit module 710, a duration module 720, and a schedule module 730. The profit module 710 can compute profits 715 for patients and associated procedures 702-1, . . . , 702-n based on historical data 760 and the schemes described herein. The duration module 720 can determine schedules of procedures 725 having total time durations consistent with a time period 790. Based on the profits 715 and the schedules 725, the schedule module 730 can compute profits 735 associated with the schedules 725 and determine the n-most profitable schedules 740 of patients for the time period 790.

In one embodiment, the duration module 720 can determine durations of procedures 702-1, . . . , 702-n based on durations of corresponding past procedures in the historical data 760. For example, in one such embodiment, the duration module 720 can determine a duration of a procedure 702-i based on an average of corresponding past procedures in the historical data 760. As previously described, data on past procedures in the historical data 760 can be based on empirical data from one or more healthcare providers. The duration module 720 can determine one or more schedules 725 having total time durations consistent with the time period 790 by summing the time durations for the procedures of the schedules 725 and accepting those schedules having total time durations less than or equal to the time period 790.

In embodiments, the scheduling scheme 700 can determine a schedule based on a compensation type of a healthcare provider based on schemes previously described herein. The compensation type can include a base salary, a bonus, a fee for a service, and/or an hourly wage. For example, in one such embodiment, the scheduling scheme 700 can determine a schedule that includes zero patients based on a compensation type that is independent of reimbursements from an insurer (e.g. a base salary that is independent of reimbursements). Also for example, in one such embodiment, the scheduling scheme 700 can determine an earnings component of a profit for a schedule based on a compensation type.

An exemplary operation of the scheduling scheme 700 will now be described. To reduce the complexity of the description, the exemplary operation illustrates two patients associated with two procedures being scheduled for a time period. Those of ordinary skill in the art will understand that the exemplary operation should be interpreted in an illustrative manner and that different operations of the scheduling scheme 700 are within the scope of the present disclosure.

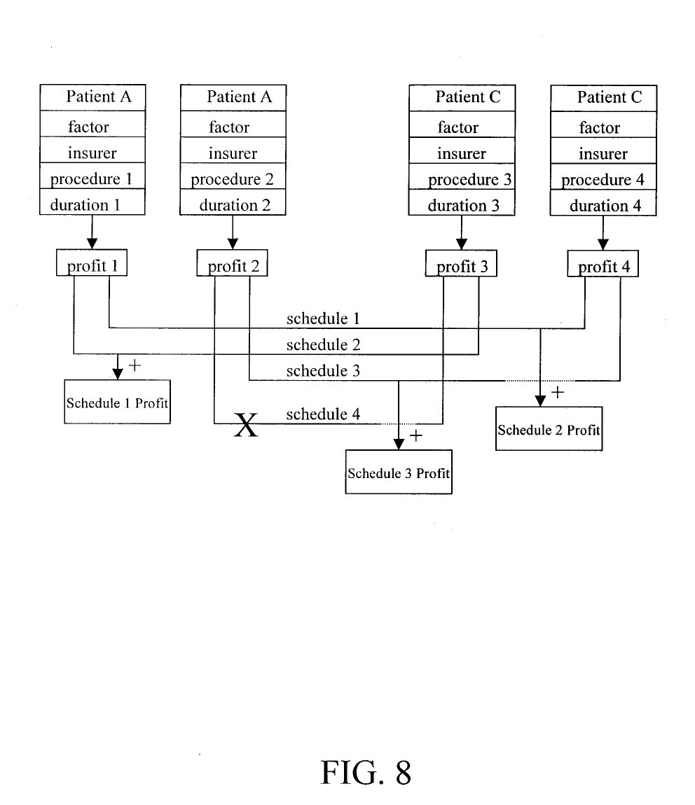

FIG. 8 shows a flow diagram of an exemplary operation of the scheduling scheme 700. The exemplary operation illustrates two patients labeled Patient A and Patient B, in which Patient A is associated with procedures 1 and 2 of durations 1 and 2 and Patient B is associated with procedures 3 and 4 of durations 3 and 4. The profit module 710 can compute patient-procedure profits 715 for Patients A and B. These profits are labeled profits 1-4 in FIG. 8. The duration module 720 can determine schedules of procedures 725 having total time durations consistent with the time period 790. The possible schedules for Patients A and B and procedures 1 and 2 are labeled schedule 1-4 in FIG. 8. For illustration, schedule 4 is marked with an X, denoting that schedule 4 does not have a total time duration consistent with time period 790. The schedule module 730 computes profits 735 for the schedules 725 by summing the profits 715 over the elements of the schedules 725. These profits are labeled schedule profits 1-3 in FIG. 8. The schedule module 730 determines the n-most profitable schedules 740 by ordering the schedules 725 based on the profits 735 associated with the schedules 725.

The scheduling scheme 700 can determine profits associated with a variety of different schedules. As previously described, in one embodiment, the scheduling scheme 700 can determine the n-most profitable schedules of patients. In such an embodiment, the scheduling scheme 700 can optimize for profit over combinations of patients and procedures consistent with the time period 790. Alternatively or in combination, in one embodiment, the scheduling scheme 700 can determine profits associated with schedules of particular procedures. For example, the scheduling scheme 700 can determine profits associated with schedules of clinically-indicated procedures, insurer-authorized procedures, procedures preferred by a healthcare provider, and/or other procedures.

Generally, the scheduling scheme 700 can be configured to select one or more schedules based on a profit associated with the schedule. For example, in one embodiment, the scheduling scheme 700 can be configured by a healthcare provider to select the most profitable schedule. In such an embodiment, the scheduling scheme 700 can compute the n-most profitable schedules 735 based on the patients and associated procedures 702-1, . . . , 702-n and select the most profitable schedule for provision to an application and/or a healthcare provider.

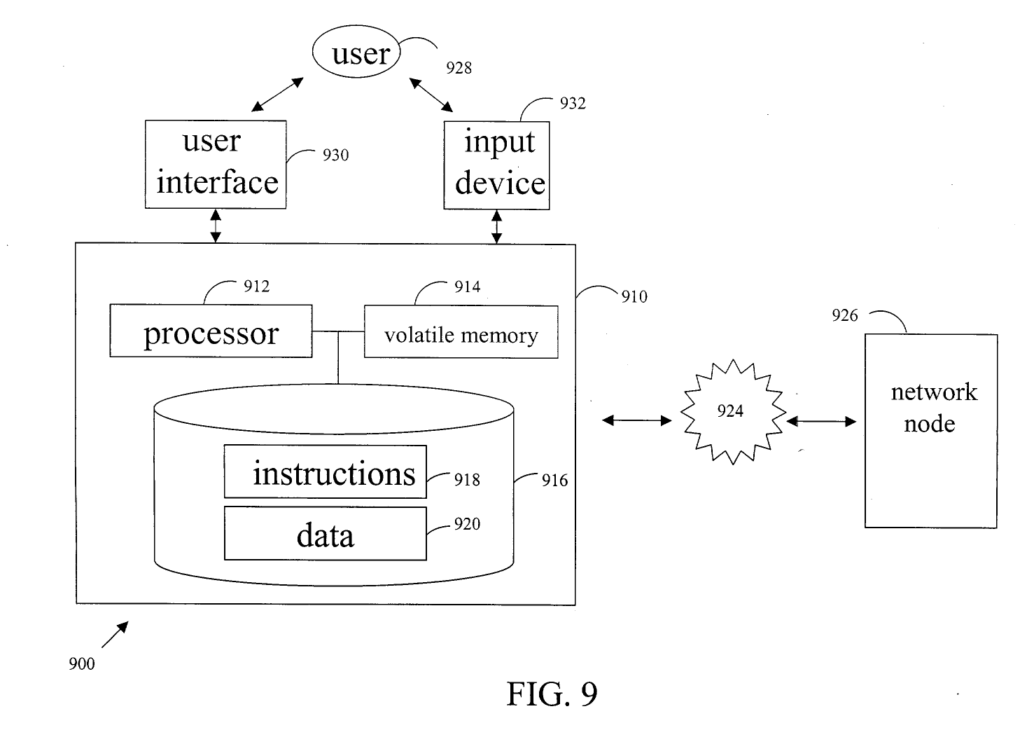

FIG. 9 shows a stand-alone system 900 configured to implement the schemes described herein, including the schemes shown in FIGS. 1-8. As shown in FIG. 9, the system 900 can include a digital data processing device 910 (“client”) having a processor 912, a volatile memory 914, and a non-volatile memory 916. The non-volatile memory 916 can store instructions 918 for the processor 912 (e.g. instructions for scheduling patients for a time period based on the schemes described herein) and data 920 (e.g. historical data, present procedure data, present insurer data, etc.). The instructions 918 and the data 920 can be transferred from the non-volatile memory 916 to the volatile memory 914 and the processor 912 during operation.

The client 910 can include a personal computer, a computer workstation (e.g., Sun, Hewlett-Packard), a laptop computer, a server computer, a mainframe computer, a handheld device (e.g., a personal digital assistant, a Pocket Personal Computer (PC), a cellular telephone, etc.), an information appliance, and/or another type of generic or special-purpose, processor-controlled device capable of receiving, processing, and/or transmitting digital data.

The processor 912 can refer to the logic circuitry that responds to and processes instructions that drive the client 910. The processor 912 can include, without limitation, a central processing unit, an arithmetic logic unit, an application specific integrated circuit, a task engine, and/or combinations, arrangements, or multiples thereof.

As shown in FIG. 9, a user 928 can interact with the client 910 by, for example, viewing a command line, using a graphical and/or other user interface 930, and entering commands via an input device 932, such as a mouse, a keyboard, a touch sensitive screen, a track ball, a keypad, etc. The user interface 930 can be generated by a graphics subsystem of the client 910, which renders the interface into an on- or off-screen surface (e.g. on a display device and/or in a video memory).

As shown in FIG. 9, the system 900 can be configured to communicate over one or more data communications networks 924 with one or more network nodes 926. The data communications network 924 can include a series of networked nodes that can be interconnected by network devices and wired and/or wireless communication lines (e.g. public carrier lines, private lines, satellite lines, etc.) that enable the network nodes to communicate. The transfer of data (e.g. messages) between network nodes can be facilitated by network devices, such as routers, switches, multiplexers, bridges, gateways, etc., that can manipulate and/or route data from an originating node to a server node regardless of dissimilarities in the network topology (e.g. bus, star, token ring), spatial distance (local, metropolitan, wide area network), transmission technology (e.g. transfer control protocol/internet protocol (TCP/IP), Systems Network Architecture), data type (e.g. data, voice, video, multimedia), nature of connection (e.g. switched, non-switched, dial-up, dedicated, or virtual), and/or physical link (e.g. optical fiber, coaxial cable, twisted pair, wireless, etc.) between the originating and server network nodes.

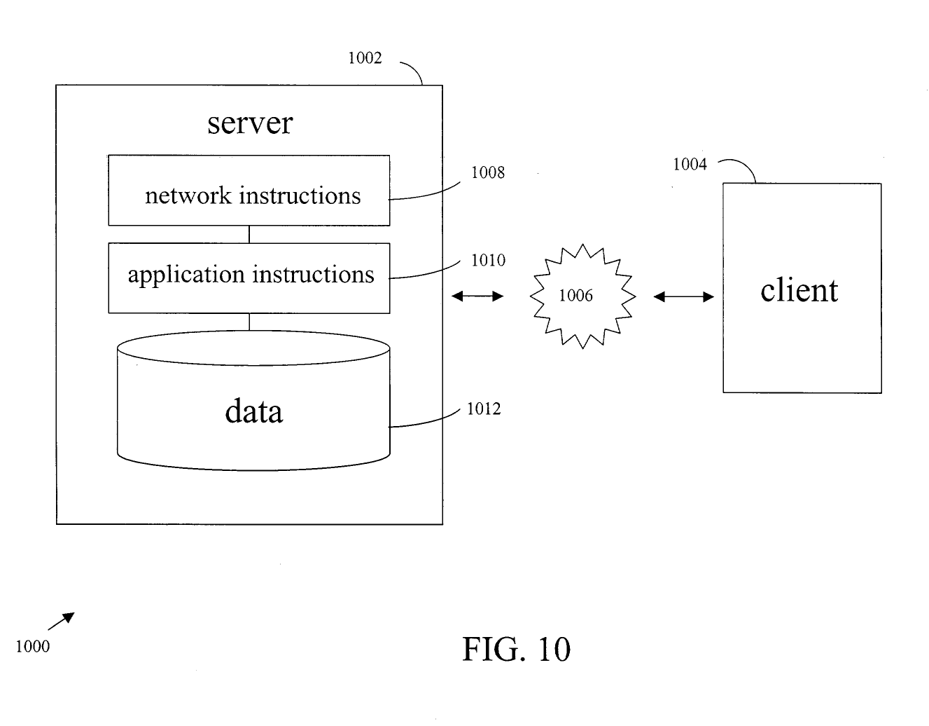

FIG. 10 shows a network-based system 1000 configured to implement the schemes described herein, including the schemes shown in FIGS. 1-8. As shown in FIG. 10, the system 1000 can include a server 1002 configured to communicate with one or more clients 1004 over one or more data communications networks 1006. The server 1002 can include network instructions 1008 for communicating over the data communications network 1006 and application instructions 1010 and data 1012 for providing application logic.

In one embodiment, the client 1004 can be configured to provide a browser (e.g. an Internet browser). In such an embodiment, the client 1004 can provide present procedure data, present insurer data, etc. over the network 1006 to the server 1002. The server 1002 can use the present data from the client 1004 an/d the data 1012 (e.g. historical data) to schedule patients for a time period based on the schemes described herein. The server 1002 can communicate an output (e.g. a profit, a schedule, etc.) to the client 1004 over the network 1006.

The schemes described herein are not limited to a hardware or software configuration; they can find applicability in many computing or processing environments. The schemes can be implemented in hardware or software, or in a combination of hardware and software. The schemes can be implemented in one or more computer programs, in which a computer program can be understood to comprise one or more processor-executable instructions. The computer programs can execute on one or more programmable processors, and can be stored on one or more storage media readable by the processor, comprising volatile and non-volatile memory and/or storage elements.

The computer programs can be implemented in high level procedural or object oriented programming language to communicate with a computer system. The computer programs can also be implemented in assembly or machine language. The language can be compiled or interpreted.

The computer programs can be stored on a storage medium or a device (e.g., compact disk (CD), digital video disk (DVD), magnetic disk, internal hard drive, external hard drive, random access memory (RAM), redundant array of independent disks (RAID), or removable memory device) that is readable by a general or special purpose programmable computer for configuring and operating the computer when the storage medium or device is read by the computer to perform the schemes described herein.

While the schemes described herein have been shown and described with reference to the shown embodiments, those of ordinary skill in the art will recognize or be able to ascertain many equivalents to the embodiments described herein by using no more than routine experimentation. Such equivalents are intended to be encompassed by the scope of the present disclosure and the appended claims.

The schemes described herein are not limited to services provided by healthcare providers. For example, the schemes described herein can be used in accounting, business, engineering, legal, and/or scientific settings to schedule clients, services, tasks, patients, projects and/or other entities for a time period.

The schemes described herein can compute profits based on one or more combinations of factors, such as one or more patient factors, procedure factors, healthcare provider factors, and/or insurer factors. Further, the schemes described herein can compute profits based on fields different than those described herein.

The schemes described herein can compute financial consequences associated with patients, procedures, and/or schedules, in which the financial consequences can include gains, losses, and/or zero returns.

Accordingly, the appended claims are not to be limited to the embodiments described herein, can comprise practices other than those described, and are to be interpreted as broadly as allowed under prevailing law.

1. A method of determining a schedule of patients for a time period, the method comprising:
providing a profit scheme capable of computing a profit associated with a procedure of a patient,
based on the profit scheme, computing profits associated with different schedules of procedures of the patients for the time period, and
based on the computed profits, selecting one of the different schedules of procedures of patients for the time period.

2. The method of claim 1, wherein providing a profit scheme comprises:
providing an earnings component representing at least one computed insurance reimbursement for the procedure, and
providing a costs component representing at least one computed value of unbillable healthcare provider time for the procedure.

3. The method of claim 2, wherein providing an earnings component comprises:
representing, in the earnings component, the at least one computed insurance reimbursement based on at least one empirical relationship between the maximum insurance reimbursement for the procedure and at least one historical reimbursement for the procedure.

4. The method of claim 2, wherein providing an earnings component comprises:
representing, in the earnings component, the at least one computed insurance reimbursement based on at least one empirical relationship among
the maximum insurance reimbursement for the procedure,
at least one patient factor comprising at least one of an age, a diagnosis, an employer, a level of impairment, a past medical history, and a monetary consequence for an unattended procedure, and
at least one historical reimbursement for the procedure.

5. The method of claim 2, wherein providing an earnings component further comprises:
providing an earnings component representing at least one computed patient co-payment for the procedure.

6. The method of claim 5, wherein providing an earnings component comprises:
representing, in the earnings component, the at least one computed patient co-payment based on at least one empirical relationship between the maximum patient co-payment for the procedure and at least one historical patient co-payment for the procedure.

7. The method of claim 5, wherein providing an earnings component comprises:
representing, in the earnings component, the at least one computed patient co-payment based on at least one empirical relationship among
a maximum patient co-payment for the procedure,
at least one patient factor comprising at least one of an age, a diagnosis, an employer, a level of impairment, a past medical history, and a monetary consequence for an unattended procedure, and
at least one historical patient co-payment for the procedure.

8. The method of claim 2, wherein providing an earnings component further comprises:
providing an earnings component based on at least one compensation type comprising at least one of a base salary, a bonus, a fee for a service, and an hourly wage.

9. The method of claim 2, wherein the at least one computed value of unbillable healthcare provider time is based on at least one of:
at least one non-patient interaction comprising at least one of at least one healthcare provider telephone call, at least one healthcare provider documentation, and at least one healthcare provider laboratory report, and
at least one unattended procedure comprising at least one of at least one patient-cancelled procedure, and at least one patient-missed procedure.

10. The method of claim 2, wherein providing a costs component comprises:
representing, in the costs component, the at least one computed value of unbillable healthcare provider time based on at least one product of:
at least one healthcare provider hourly rate, and
at least one amount of unbillable healthcare provider time for the procedure.

11. The method of claim 10, wherein the at least one amount of unbillable healthcare provider time is based on at least one average of amounts of historical unbillable healthcare provider time for the procedure.

12. The method of claim 10, wherein the at least one amount of unbillable healthcare provider time is based on at least one empirical relationship between
at least one patient factor comprising at least one of an age, a diagnosis, an employer, a level of impairment, a past medical history, and a monetary consequence for an unattended procedure, and
at least one amount of historical unbillable healthcare provider time for the procedure.

13. The method of claim 2, wherein providing a costs component further comprises:
providing a costs component representing at least one computed business cost for the procedure.

14. The method of claim 13, wherein providing a costs component comprises:
representing, in the costs component, the at least one computed business cost based on at least one proportional relationship between
at least one outlay comprising at least one of
a rent payment,
a utilities payment,
a labor cost, and
a malpractice insurance premium, and
at least one duration of at least one procedure.

15. The method of claim 1, wherein computing profits comprises:
based on the profit scheme, computing profits associated with different procedures of at least one patient.

16. The method of claim 15, wherein the different procedures comprise at least one of:
at least one clinically-indicated procedure, and
at least one insurer-authorized procedure.

17. The method of claim 1, further comprising:
based on at least one of
at least one clinically-indicated procedure, and
at least one insurer-authorized procedure,
generating the different schedules of procedures of the patients.

18. A method of determining a procedure of a patient, the method comprising
providing a profit scheme based on
at least one computed insurance reimbursement, and
at least one computed value of unbillable healthcare provider time
for a procedure of a patient,
based on the profit scheme, computing profits associated with different procedures of the patient, and
based on the computed profits, selecting one of the different procedures of the patient.

19. The method of claim 18, wherein providing a profit scheme further comprises:
providing a profit scheme based on at least one compensation type comprising at least one of a base salary, a bonus, a fee for a service, and an hourly wage.

20. The method of claim 18, wherein the at least one computed insurance reimbursement is based on at least one empirical relationship between the maximum insurance reimbursement for the procedure and at least one historical reimbursement for the procedure.

21. The method of claim 18, wherein the at least one computed value of unbillable healthcare provider time is based on at least one of:
at least one non-patient interaction comprising at least one of at least one healthcare provider telephone call, at least one healthcare provider documentation, and at least one healthcare provider laboratory report, and
at least one unattended procedure comprising at least one of at least one patient-cancelled procedure and at least one patient-missed procedure.

22. The method of claim 18, wherein the at least one computed value of unbillable healthcare provider time is based on at least one product of:
at least one healthcare provider hourly rate, and
at least one amount of unbillable healthcare provider time for the procedure.

23. The method of claim 22, wherein the at least one amount of unbillable healthcare provider time is based on one of:
at least one average of amounts of historical unbillable healthcare provider time for the procedure, and
at least one empirical relationship between
at least one patient factor comprising at least one of an age, a diagnosis, an employer, a level of impairment, a past medical history, and a monetary consequence for an unattended procedure, and
at least one amount of historical unbillable healthcare provider time for the procedure.

24. The method of claim 18, wherein the different procedures comprise at least one of:
at least one clinically-indicated procedure, and
at least one insurer-authorized procedure.

25. A method of computing a profit associated with a schedule of patients, the method comprising:
providing a profit scheme based on
at least one computed insurance reimbursement, and
at least one computed value of unbillable healthcare provider time
for a procedure of a patient,
based on the profit scheme, computing profits associated with the procedures of the patients of the schedule, and
based on the computed profits, computing the profit associated with the schedule.

26. The method of claim 25, wherein providing a profit scheme further comprises:
providing a profit scheme based on at least one compensation type including at least one of a base salary, a bonus, a fee for a service, and an hourly wage.

27. The method of claim 25, wherein the at least one computed insurance reimbursement is based on at least one empirical relationship between the maximum insurance reimbursement for the procedure and at least one historical reimbursement for the procedure.

28. The method of claim 25, wherein the at least one computed value of unbillable healthcare provider time is based on at least one of:
at least one non-patient interaction comprising at least one of at least one healthcare provider telephone call, at least one healthcare provider documentation, and at least one healthcare provider laboratory report, and
at least one unattended procedure comprising at least one of at least one patient-cancelled procedure and at least one patient-missed procedure.

29. The method of claim 25, wherein the at least one computed value of unbillable healthcare provider time is based on at least one product of:
at least one healthcare provider hourly rate, and
at least one amount of unbillable healthcare provider time for the procedure.

30. The method of claim 29, wherein the at least one amount of unbillable healthcare provider time is based on one of:
at least one average of amounts of historical unbillable healthcare provider time for the procedure, and
at least one empirical relationship between
at least one patient factor comprising at least one of an age, a diagnosis, an employer, a level of impairment, a past medical history, and a monetary consequence for an unattended procedure, and
at least one amount of historical unbillable healthcare provider time for the procedure.

31. A processor program for determining a schedule of patients for a time period, the processor program being stored on a processor readable medium and comprising instructions to cause a processor to:
based on a profit scheme capable of computing a profit associated with a procedure of a patient, compute profits associated with different schedules of procedures of patients for the time period, and
based on the computed profits, select one of the different schedules of procedures of patients for the time period.

32. The processor program of claim 31, wherein the profit scheme is based on:
at least one computed insurance reimbursement for a procedure of a patient, and
at least one computed value of unbillable healthcare provider time for a procedure of a patient.

33. The processor program of claim 31, wherein the profit scheme is further based on at least one compensation type comprising at least one of a base salary, a bonus, a fee for a service, and an hourly wage.

34. The processor program of claim 32, wherein the at least one computed insurance reimbursement is based on at least one empirical relationship between the maximum insurance reimbursement for the procedure and at least one historical reimbursement for the procedure.

35. The processor program of claim 32, wherein the at least one computed value of unbillable healthcare provider time is based on at least one of:
at least one non-patient interaction comprising at least one of at least one healthcare provider telephone call, at least one healthcare provider documentation, and at least one healthcare provider laboratory report, and
at least one unattended procedure comprising at least one of at least one patient-cancelled procedure and at least one patient-missed procedure.

36. The processor program of claim 32, wherein the at least one computed value of unbillable healthcare provider time is based on at least one product of:
at least one healthcare provider hourly rate,(and
at least one amount of unbillable healthcare provider time for the procedure.

37. The processor program of claim 36, wherein the at least one amount of unbillable healthcare provider time is based on one of:
at least one average of amounts of historical unbillable healthcare provider time for the procedure, and
at least one empirical relationship between
at least one patient factor comprising at least one of an age, a diagnosis, an employer, a level of impairment, a past medical history, and a monetary consequence for an unattended procedure, and
at least one amount of historical unbillable healthcare provider time for the procedure.

38. The processor program of claim 31, wherein the instructions to compute profits comprise instructions to:
based on the profit scheme, compute profits associated with different procedures of at least one patient.

39. The processor program of claim 38, wherein the different procedures comprise at least one of:
at least one clinically-indicated procedure, and
at least one insurer-authorized procedure.

40. The processor program of claim 31, further comprising instructions to:
based on at least one of
at least one clinically-indicated procedure, and
at least one insurer-authorized procedure,
generate the different schedules of procedures of the patients.
